(19) United States
(12) Patent Application Publication
(10) Pub. No.: US 2025/0385578 A1
(43) Pub. Date: Dec. 18, 2025

(54) STATION FOR FORMING INDUCTIVE WINDINGS OF ELECTRIC MACHINES

(71) Applicant: ATOP S.P.A., Barberino Tavarnelle (IT)

(72) Inventors: Rubino CORBINELLI, Poggibonsi, Frazione Staggia (IT); Daniele NOCCIOLINI, Firenze (IT)

(21) Appl. No.: 19/130,263

(22) PCT Filed: Nov. 27, 2023
(86) PCT No.: PCT/EP2023/083188

§ 371 Date: May 15, 2025

(30) Foreign Application Priority Data
Nov. 28, 2022 (IT) 102022000024435

(51) Int. Cl. H02K 15/0428

(52) U.S. Cl. CPC H02K 15/0428

(57) ABSTRACT

A station for forming a lattice of inductive windings of electric conductors of the hairpin type, wherein each conductor is fork-shaped with two straight shanks of different length joined by a bridge, comprising a forming tool configured to temporarily accommodate a plurality of conductors, so as to form the lattice with the bridges of each conductor arranged substantially at the same axial height; a pushing element configured to be moved along the first axis of symmetry and comprising a pusher provided with an operative face; an operative face of the pusher abuts against the electric conductors at different axial heights along a radial direction and moves axially while remaining in abutment against the terminal fronts, until it partially lifts the shanks of the electric conductors that form the lattice from the forming tool.

The present invention relates to a station for forming inductive windings of electric machines.

Normally the inductive windings present in electric machines (with particular reference to stator or rotor windings of motors, alternators, dynamos and generators in general) are provided by means of portions of conductor wire, conveniently shaped, which are inserted into through slots present in a ferromagnetic core (such shaped portions are called “hairpins” in the sector). The terminal shanks of wire portions are then coupled together (generally welded) according to a pattern that makes it possible to provide a continuous winding, distributed according to a specific circuit architecture.

Normally the procedure uses wire portions of length greater than that strictly necessary, for the purpose of facilitating some operative steps.

A greater length of the protruding shanks of the wire portions is useful during the creation of a lattice constituted by such portions on a forming tool (the portions are normally inserted one by one into specific seats of such forming tool, where they temporarily remain until the entire lattice is created), followed by their block extraction and transfer to the ferromagnetic core (wherein each wire portion will be inserted into the correct slot). Wire portions with longer shanks in fact enable an easy extraction of the lattice from the forming tool, taking advantage of the protruding part thereof to execute this operation (by applying a push on the shanks protruding from the forming tool, in such a direction as to extract the entire lattice from it).

Furthermore, having wire portions that have some longer shanks makes it possible to separate some pairs of shanks from the remaining ones, by taking advantage of the greater length of some of them: it is in fact a very simple matter to insert separator tools, using the empty spaces present between a long end and a short end.

Conversely, such an embodiment implies the production of a considerable amount of waste, in that the longer shanks need to be cut off before the step of coupling (welding) them. The cutting is necessary in order to adapt the length of the shanks to the right space occupation, and in order to provide flat terminal fronts at the shanks, a necessary condition for efficiently welding them together according to conventional techniques. This operation also requires the presence of an adapted cutting station in the plant, which entails considerable increases in costs, both at the purchasing stage (these are expensive machines) and in use (the station will consume energy in order to work and will need to be periodically subjected to checks and maintenance).

The possibility is also known of providing plants wherein it is not necessary to cut the wire portions, in that the shanks are already at the correct length to ensure the subsequent operations of bending and coupling according to the predefined circuit diagram. In this case however, the terminal shanks of the wires must have the terminal front flat: this is necessary in order to be able to proceed with the subsequent operations of welding the pairs of shanks.

However, flat terminal fronts are extremely inconvenient during operations to insert the shanks, firstly, into the seats of the forming tool (during the formation of the lattice) and, subsequently, once the lattice is completely formed, into the slots of the ferromagnetic core (during the introduction of the lattice into the ferromagnetic core). The fact of having pointed shanks, in fact, facilitates the insertion operations, as the respective inclined surfaces can be used to guide each end into the corresponding seat and/or slot.

For this reason, the insertion operations require the use of very precise machines, or the adoption of auxiliary components that ensure the exact alignment of each terminal front with the corresponding seat (and/or with the corresponding slot). These constructive measures imply higher purchase costs of the components necessary for the correct operation of the plant, and an extreme precision of construction/installation. Such measures imply higher costs of providing such plants.

WO2022136488 by this same Applicant discloses a method that makes it possible to weld together the terminal portions of shanks that have a pointed terminal front. The difficulties that lie in the operations of insertion and necking (i.e. regrouping or subdivision) into pairs (or groups) of the shanks of wires do not allow to apply the method described in WO2022136488 effectively and economically advantageously.

The aim of the present invention is to solve the above-mentioned drawbacks, by providing a station for forming inductive windings of electric machines that can easily operate on lattices of conductors wherein the shanks do not need to be cut before they are coupled together in groups of at least two shanks.

Within this aim, an object of the invention is to provide a station for forming inductive windings of electric machines that does not need to be associated with a station for cutting the shanks.

Another object of the invention is to provide a station for forming inductive windings of electric machines that does not entail the use of high-precision machines for executing the operations to insert the shanks into respective seats of the forming tool, during the formation of the lattice, and into the slots of the ferromagnetic core, during the introduction of the lattice into the ferromagnetic core.

Another object of the invention is to provide a station for forming inductive windings of electric machines that does not entail the adoption of auxiliary components to ensure the precise alignment of each terminal front with the respective seats of the forming tool, during the formation of the lattice, and with the slots of the ferromagnetic core, during the introduction of the lattice into the ferromagnetic core.

Another object of the invention is to provide an apparatus for forming inductive windings of electric machines that makes it possible to apply the teachings of WO2022136488 in the final step of coupling separate shanks of wires by way of a welding process.

Another object of the present invention is to provide a station and an apparatus for forming inductive windings of electric machines which is of low cost, easily and practically implemented, and safe in use.

This aim and these objects are achieved by a station according to claim 1.

Such aim and such objects are also achieved by means of an apparatus according to claim 6.

Such aim and such objects are also achieved by means of a method according to claim 11 and a method according to claim 13.

Further characteristics and advantages of the invention will become better apparent from the detailed description that follows of a preferred, but not exclusive, embodiment of the station and of the apparatus, for forming inductive windings of electric machines, which is illustrated by way of non-limiting example in the accompanying drawings wherein:

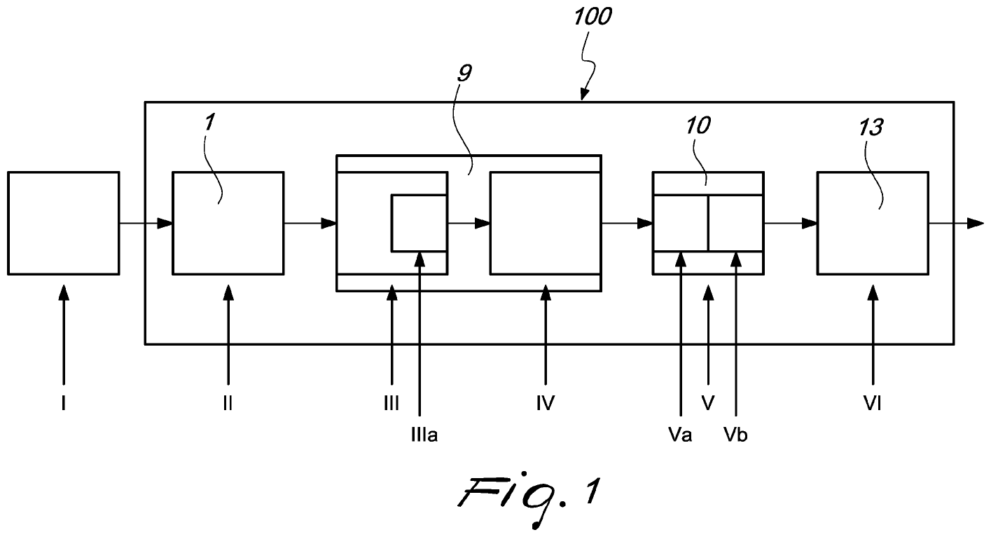

FIG. 1 is a block diagram of the apparatus for forming inductive windings of electric machines according to the invention;

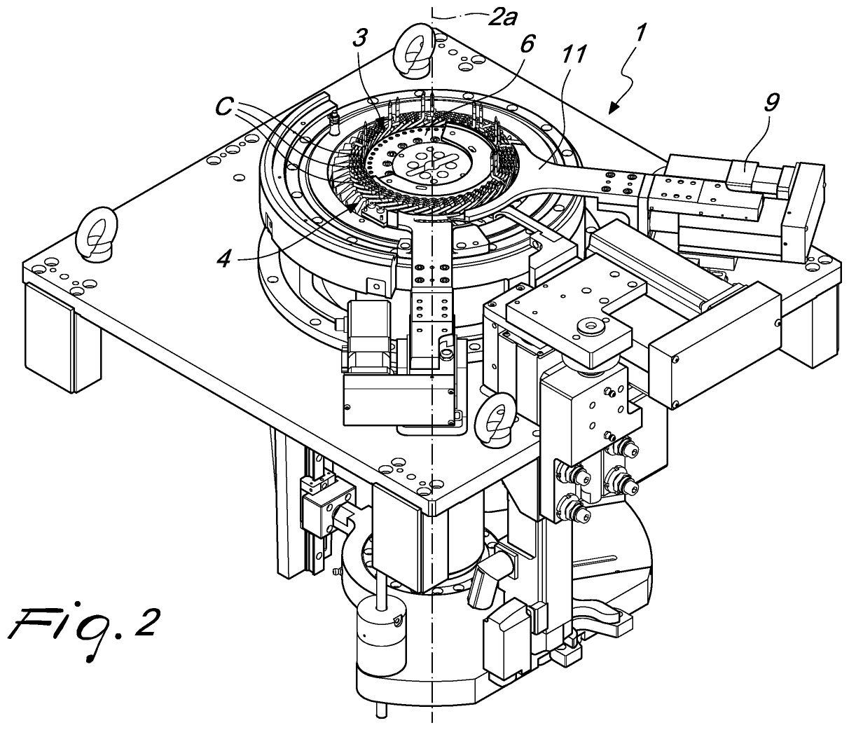

FIG. 2 is a schematic perspective view of an embodiment of a station configured for forming a lattice of electric conductors of an apparatus for forming inductive windings of electric machines according to the invention, in a configuration of full accommodation of electric conductors;

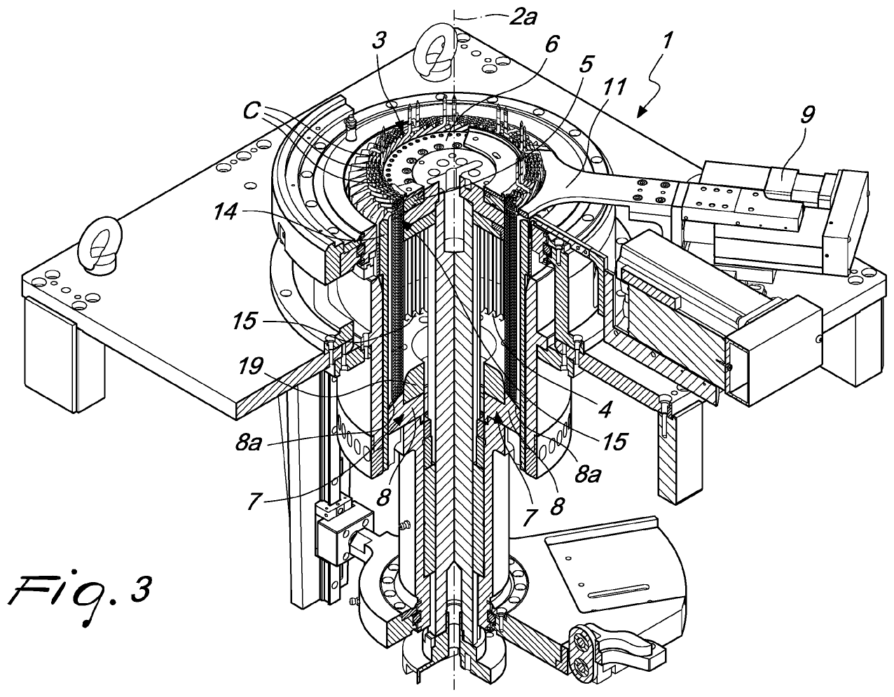

FIG. 3 is a partially cross-sectional schematic perspective view of the station of FIG. 1 in the configuration of FIG. 1;

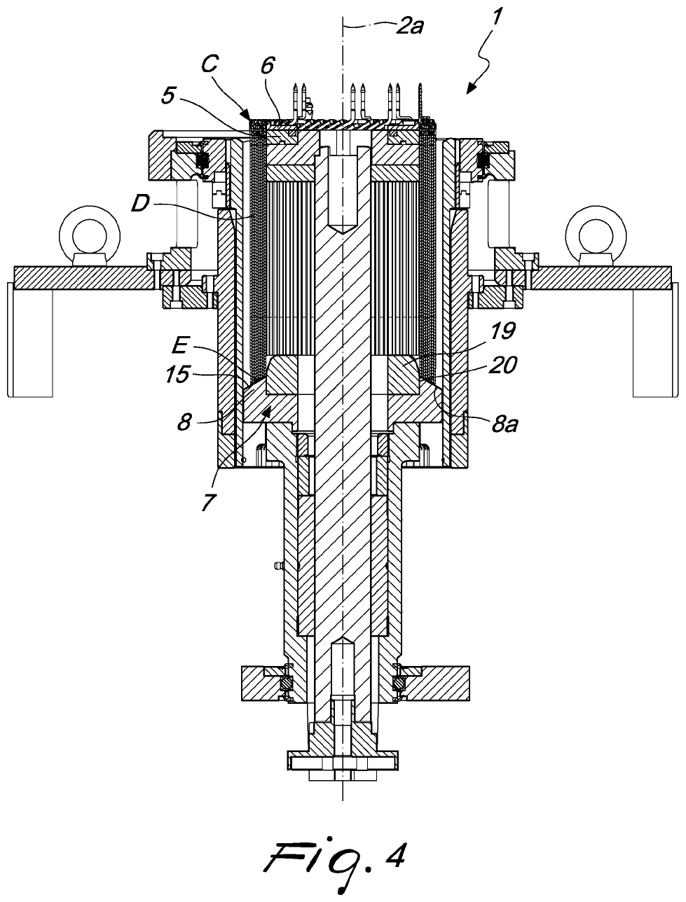

FIG. 4 is a cross-sectional schematic view, taken along a transverse plane passing through the main axis of symmetry, of the station of FIG. 1 in the configuration of FIG. 1;

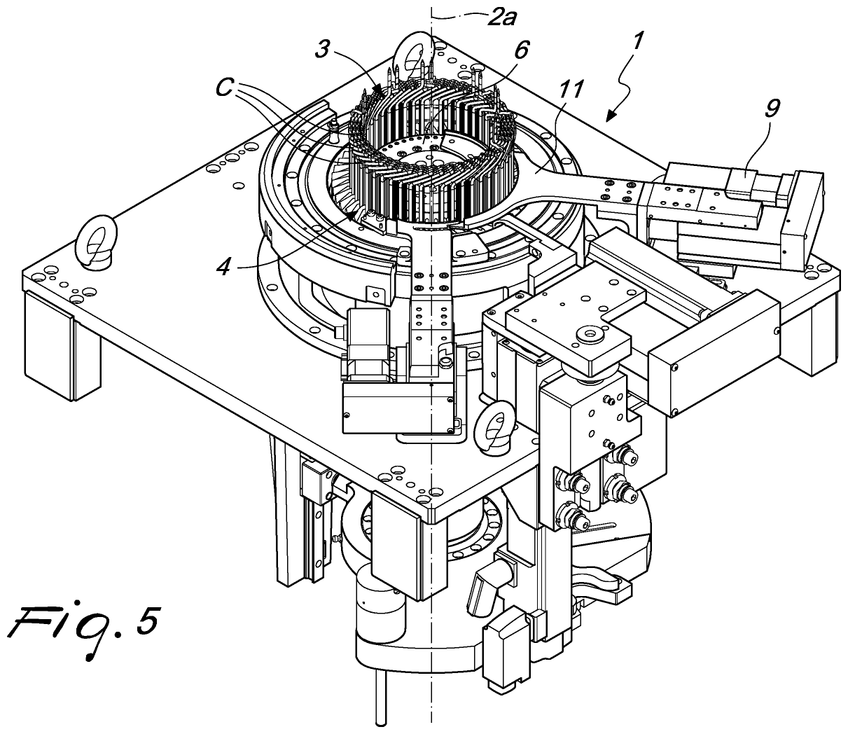

FIG. 5 is a schematic perspective view of the station of FIG. 1 in a configuration of partial expulsion of the electric conductors, which are kept protruding from the surface of the forming tool that accommodates them;

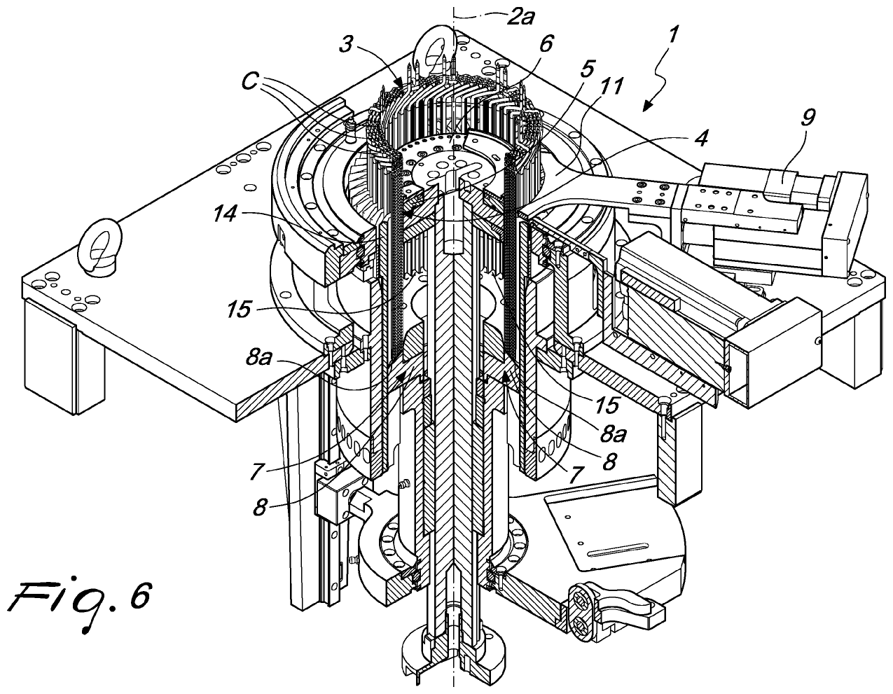

FIG. 6 is a partially cross-sectional schematic perspective view of the station of FIG. 1 in the configuration of FIG. 5;

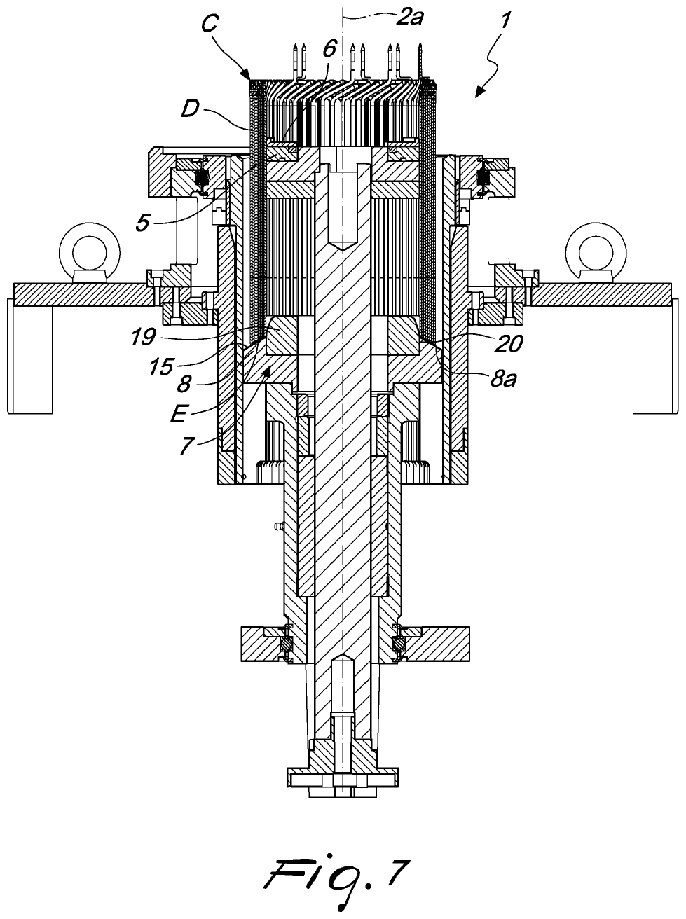

FIG. 7 is a cross-sectional schematic view, taken along a transverse plane passing through the main axis of symmetry, of the station of FIG. 1 in the configuration of FIG. 5;

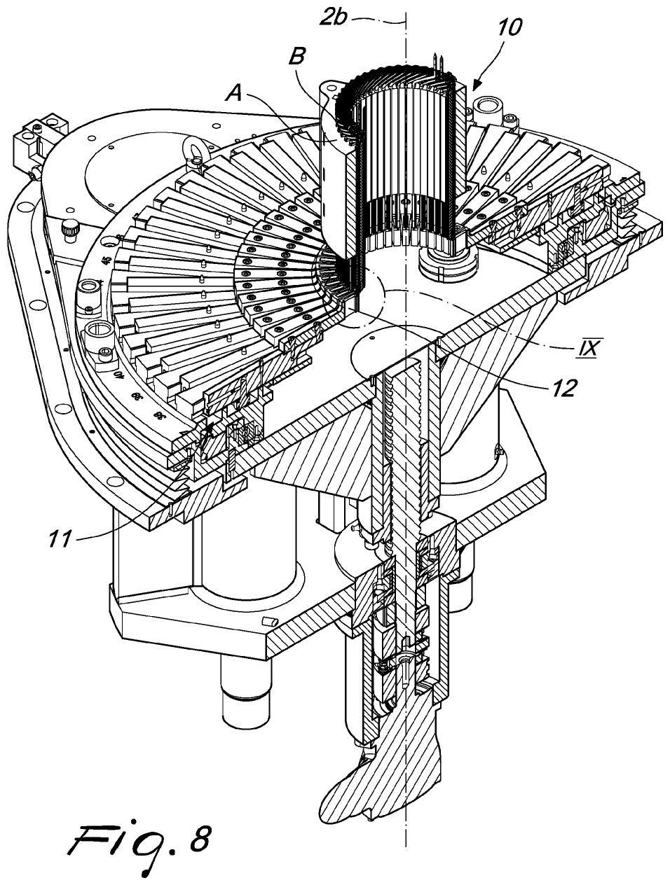

FIG. 8 is a cross-sectional view, taken along a transverse plane passing through the main axis of symmetry, of an embodiment of a grouping station provided with at least one element configured for grouping, into groups, at least one portion of said shanks of said electric conductors protruding from a respective ferromagnetic core;

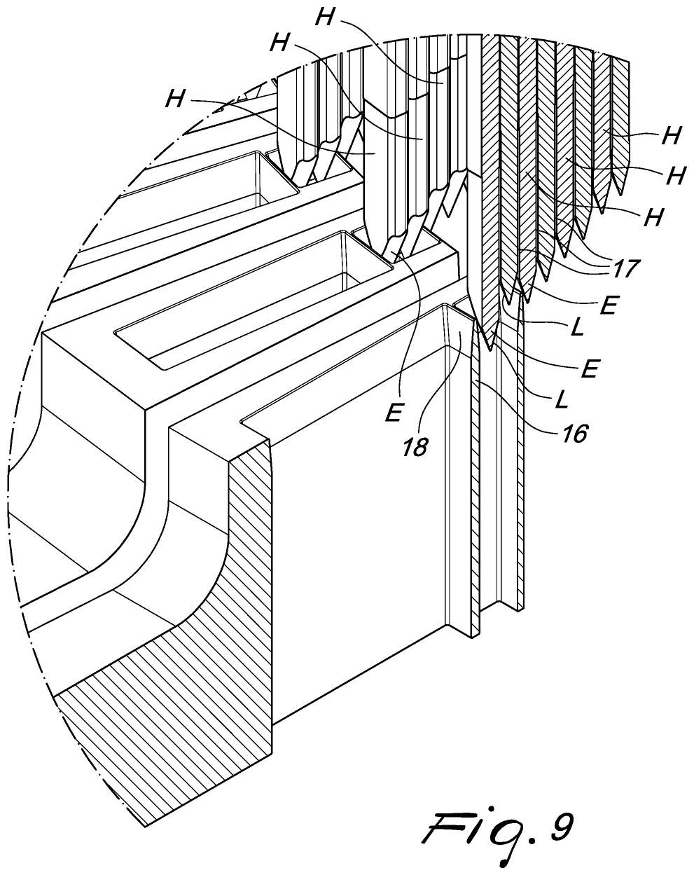

FIG. 9 is an enlargement of the detail XI indicated in FIG. 8;

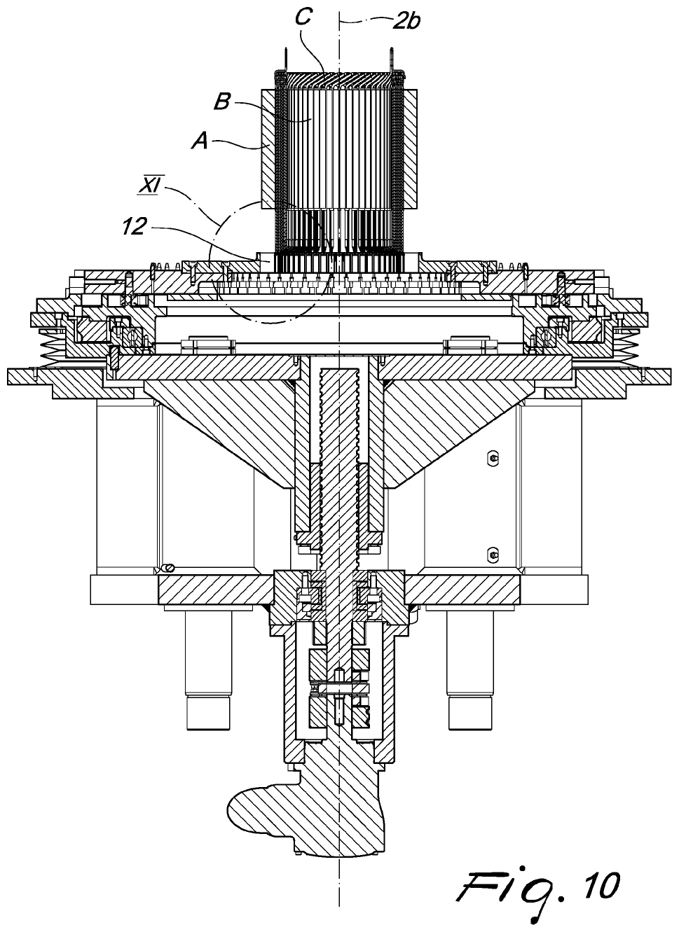

FIG. 10 is a cross-sectional schematic view, taken along a transverse plane passing through the main axis of symmetry, of the grouping station of FIG. 8;

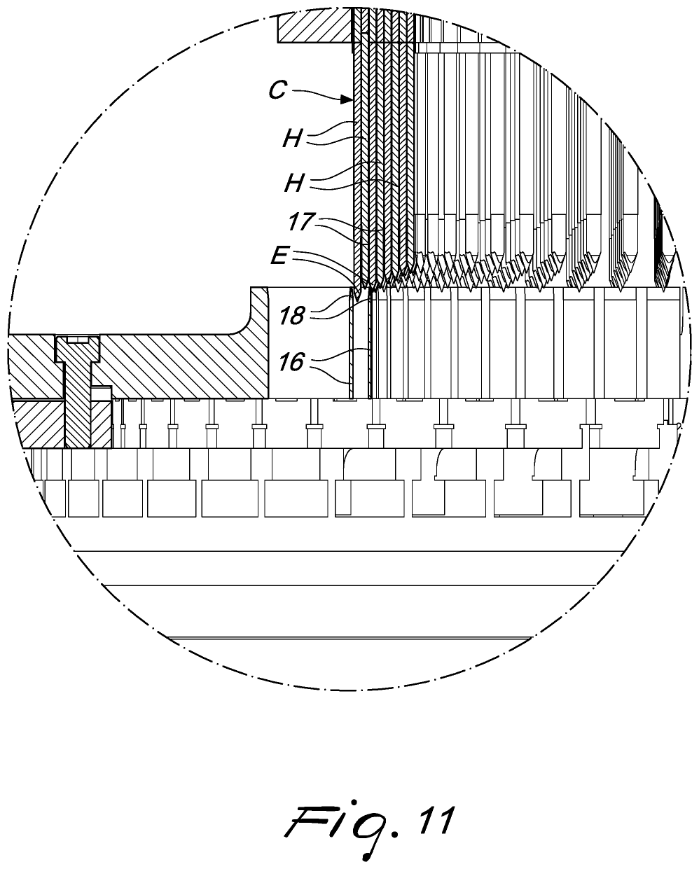

FIG. 11 is an enlargement of the detail XI indicated in FIG. 10;

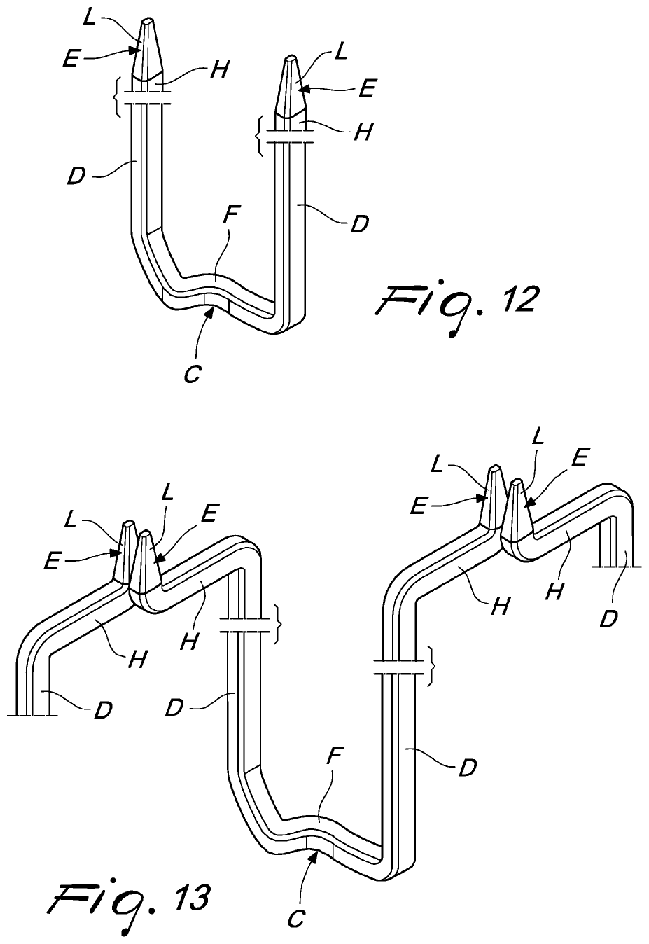

FIG. 12 is a schematic perspective view of an electrical conductor of the type adapted to be processed by the apparatus according to the invention;

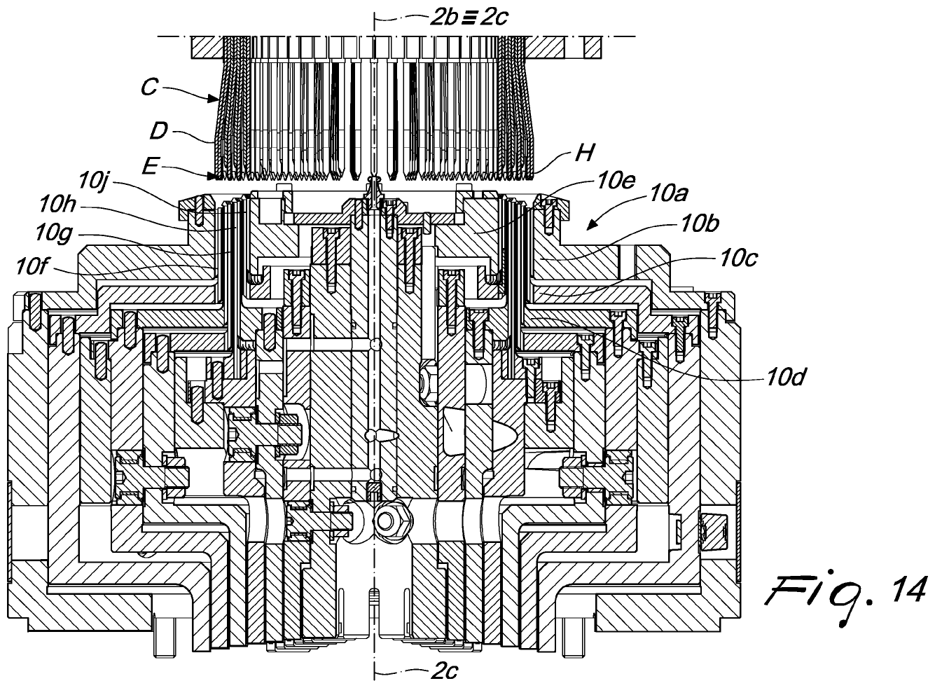

FIG. 13 is a schematic perspective view of the arrangement of the electric conductors before they are coupled together by welding;

FIG. 14 is a schematic perspective view of a possible twisting element of a grouping device of an apparatus according to the invention.

With particular reference to the figures, the reference numeral 1 generally designates a station for forming inductive windings of electric machines.

In particular, the inductive windings produced by the station 1 can be windings of stators or rotors of electric machines such as motors, alternators, dynamos and the like.

However, the possibility is not ruled out of using the station 1 to provide inductive windings intended for transformers, electromagnetic brakes, linear induction motors and the like.

In all these cases, there is a core made of ferromagnetic material A, provided with through slots B (generally mutually parallel) in which the electric conductors C that constitute the winding can be accommodated.

The electric conductors C will preferably be constituted by portions of electric wire, generally at least partially coated with a layer of insulating (dielectric) material. A portion of shaped electrical wire intended to be used to provide the winding is known in the sector as a “hairpin” because of its characteristic shape.

The conductors C will comprise two shanks D which have a terminal front E and will be fork-shaped. Such two shanks D will be connected together by way of a central portion F which will constitute a connecting bridge (defined simply as a bridge F) between them.

The shanks D must be accommodated in the slots B of the ferromagnetic core A, while the central portion F will remain outside the core A (substantially facing and proximate to a head G thereof). The connection (through the coupling of the terminal fronts E grouped into pairs or groups) of a plurality of conductors C (in electrical continuity with each other) according to a predefined pattern will constitute the inductive winding.

The station 1 is configured to form a lattice 3 of electric conductors C arranged according to a predefined pattern. The station 1 is provided with a tool 4 for the temporary accommodation of the conductors C (with the shanks D inserted in the respective seats 5 and the bridge F facing an upper head 6 of the tool 4) and the formation of the lattice 3.

The introduction of the conductors C (the hairpins) into the station 1 for forming the lattice 3 (generally known in the sector as a “basket”), is done according to the background art (already illustrated in previous patent documents by this same Applicant: such introduction can be advantageously performed by an automatic device for introducing the conductor elements C, preferably one by one, for more accurate positioning inside the forming tool 4.

The station 1 comprises a forming tool 4 configured to temporarily accommodate a plurality of such conductors C about a first axis of symmetry 2a, so as to form the lattice 3 with the bridges F of each conductor C arranged substantially at the same axial height. The station 1 further comprises a pushing element 7 configured to be moved along the first axis of symmetry 2a so as to push the lattice 3 with respect to the forming tool 4 so that it exits (i.e. the lattice 3 is pushed outward with respect to the forming tool 4). The pushing element 7 comprises, in turn, a pusher 8 provided with an operative face 8a designed to abut against terminal fronts E of the shanks D of the electric conductors C which form the lattice 3.

The operative face 8a of the pusher 8 has a radially-inclined annular configuration with a protrusion that decreases as it progresses further away from the first axis of symmetry 2a: in practice, the operative face 8a of the pusher 8 has a substantially convex shape (with the maximum protrusion proximate to the axis 2a). In fact, the shape of the active surface 8a is designed to abut against the electric conductors C at different axial heights along a radial direction.

The pusher 8 will conveniently be configured to be movable parallel to the first axis of symmetry 2a from a first configuration, wherein it is arranged at a predefined maximum distance from the second surface 6, to a second configuration, wherein the operative face 8a of the pusher 8 is closer to the second surface 6 with respect to the first configuration (the two configurations will be contained within a stroke of the pusher 8 the extent of which is selected at the design stage in conformance with expected operating requirements), and the shanks D of the electric conductors C protrude partially from the second surface 6.

The operative face 8a is in fact configured to move axially while remaining in abutment (therefore striking) against the terminal fronts E, until it partially lifts the shanks D of the electric conductors C that form the lattice 3 from the forming tool 4 (i.e., by means of synchronized lifting, making all the conductors C that form the lattice 3 “emerge” or “rise” with respect to the top of the forming tool 4), so as to enable a subsequent extraction of the lattice 3 from the forming tool 4 by means of an extractor element 9 (provided with a grip tab 11 at its end, which is configured to retain the lattice 3).

It is important to point out that no plastic deformations are envisaged in the shanks D and/or in the electric conductors C as a result of this lifting operation.

In fact, the length of the axial stroke performed by the pusher 8, from when it comes into contact with the terminal fronts E, is equivalent to the axial movement of the conductors C along directions parallel to the axis 2a: in practice the pusher 8 performs a synchronized lifting of all the conductors C.

As a consequence, the bridges F of the conductor elements C will remain substantially mutually aligned (or more correctly they will maintain their respective relative axial heights) during the lifting (and also once the lifting is concluded), prior to the extraction of the lattice 3, following which the latter will be moved in order to transfer it to the station for inserting it into the through slot B of the ferromagnetic core A.

With particular reference to an embodiment of undoubted practical and applicative interest, the operative face 8a of the pusher 8 has a configuration (shape structure) of a type chosen at least among frustum-shaped, hemispherical, spheroidal, parabolic-shaped, hyperboloid-shaped, polyhedral and/or combinations thereof.

It should be noted that the substantially frustum-shaped operative face of the pusher 8 of the pushing element 7 for extracting the lattice 3 from the tool 4 is facing toward the seats 5 of the forming tool 4.

The pusher 8 (and, obviously, its operative face 8a which is integral with it) will be conveniently moveable from a first configuration wherein it is arranged at a predefined distance from the forming tool 4 (shown by way of non-limiting example in the accompanying FIGS. 3 and 4) to a second configuration (shown by way of non-limiting example in the accompanying FIGS. 6 and 7) wherein it faces and is proximate to a first surface 15 of said forming tool 4 (the first surface 15, corresponding, in the accompanying figures, to a lower head of the tool 4).

It should be noted that, in the transition from the first to the second configuration, a contact is generated between the fronts E and the operative face 8a in order to perform the synchronized lifting. In fact, in the second configuration such lifting will have already taken place, and such lifting will in fact be due to the axial movement of the pusher 8.

The forming tool 4 will therefore advantageously comprise a first surface 15 and a second surface 6 which corresponds to the upper head 6 of the tool 4, arranged opposite to the first, with respect to which the bridges F of the conductors C that form the lattice 3 will be protruding.

In such second configuration the substantially frustum-shaped operative face of the pusher 8 will positively abut against the terminal front E of the shanks C of the electric conductors C, so determining a partial egress thereof from the seats 5 and a protrusion thereof from a second surface (which coincides with the upper head 6) of the forming tool 4.

In practice, the arrangement of the lattice 3 can be observed by examining the accompanying FIGS. 2, 3, 4, 5, 6, 7 (which are provided by way of non-limiting example): in particular in FIGS. 2, 3 and 4 it is possible to see the arrangement of the lattice 3 when the pusher 8 (and its active surface) are located in the cited first configuration, while in FIGS. 5, 6 and 7 it is possible to see the arrangement of the lattice 3 when the pusher 8 (and its active surface) are located in the cited second configuration.

The forming tool 4 can profitably comprise a main body 14 which is symmetrical with respect to the first axis of symmetry 2a and is provided with a plurality of seats 5. Each one of such seats 5 will be configured to accommodate at least one shank D of the electrical conductor C in a direction parallel to the first axis of symmetry 2a.

It should be noted that the seats 5 can profitably be arranged on the main body 14 in an annulus and can advantageously be mutually distributed with the same geometry as the slots B of a corresponding ferromagnetic core A.

In this manner the lattice 3, that will be formed on the tool 4, will have a shape and dimensions that are such that it can be transferred onto a corresponding ferromagnetic core A, without it being necessary to make any modification to it.

In a particularly efficient applicative embodiment, the seats 5 can advantageously be arranged circumferentially (i.e. along a circumference, preferably centered with respect to the axis 2a) separated from each other by a respective radial septum.

The pusher 8 will conveniently be configured to be movable parallel to the first axis of symmetry 2a from a first configuration, wherein it is arranged at a predefined maximum distance from the second surface 6, to a second configuration, wherein the operative face 8a of the pusher 8 is closer to the second surface 6 with respect to the first configuration (the two configurations will be contained within a stroke of the pusher 8 the extent of which is selected at the design stage in conformance with expected operating requirements), and the shanks D of the electric conductors C protrude partially from the second surface 6.

It should be noted that the forming tool 4 can advantageously comprise a containment element 19, which is symmetrical with the first axis 2a, above and concentric with the pusher 8, and integrally moveable with said pusher 8. Such containment element 19 will be dimensioned so that the shape of its lower surface is compatible with the shape of the upper surface of the pusher 8, so ensuring that the one is stably resting on the other. The containment element 19 will have a substantially cylindrical geometry, at least in the part in contact with the pusher 8, and can be tapered in its upper part, for example frustum-shaped, toroidal or the like. It should be noted that the containment element 19 will have a diameter slightly smaller than the distance of the apical part of the pusher 8, and the corresponding operative face 8a, from the axis of symmetry 2a of said tool, so as to be inserted inside it. Such containment element 19 will advantageously comprise at least one first cylindrical side surface 20, which will protrude with respect to the pusher 8 in the direction of the first axis of symmetry 2a, and will be configured to radially contain the shanks D of the conductor elements C. This first cylindrical side surface 20 will optionally act as a physical containment/barrier to the shanks D of the conductor elements C positioned further inside the lattice without causing plastic deformations to the conductors C, thus ensuring greater stability both during the insertion of the conductor elements C into the forming tool 4 and during the lifting of the lattice 3 once it has been created.

The present invention also relates to an apparatus 100 for forming inductive windings arranged within slots B of a ferromagnetic core A of an electric machine, that comprises at least one station 1 for forming lattices 3 of inductive windings of the type described previously.

The apparatus 100 further comprises an extractor element 9 configured to extract the lattice 3 of electric conductors C from the forming tool 4 (it is provided with a grip tab 11 at its end, which is configured to retain the lattice 3) and subsequently insert it into a ferromagnetic core A which is symmetrical with respect to a second axis of symmetry 2b, so that each shank D of the conductors C is accommodated in a respective slot B of such core A.

The apparatus 100 further comprises a grouping device 10 configured for grouping, i.e. regrouping, the shanks D in groups. Each one of such groups will comprise at least shanks D of the conductors C arranged in the core A that are arranged substantially at a same radial distance from the second axis of symmetry 2b.

Such grouping device 10 will conveniently be dimensioned to affect a longitudinal portion H that is contiguous with the terminal front E for each shank D of the group.

It should be noted that the grouping device 10 can conveniently comprise a widening element 12, configured and dimensioned, firstly, to effect a translation parallel to the second axis of symmetry 2b of the conductors C, so as to be inserted into a gap 17 present between two radially adjacent shanks D of distinct electric conductors C, affecting the longitudinal portion H of the shanks D up to a predefined axial height and, secondly, for an additional translation along a radial direction with respect to the second axis of symmetry 2b, for the at least partial deformation of portions H of the shanks D thus causing them to move away from the second axis of symmetry 2b.

The widening element 12 comprises at least one septum 16 configured and dimensioned to be inserted axially into the gap 17, wherein the at least one septum 16 comprises an edge 18 configured and dimensioned, firstly, to face the terminal front E of the shanks D during the translation along the direction parallel to the second axis of symmetry 2b, and, secondly, to abut against parts of the terminal front E of one of the two shanks D that delimit the gap 17.

It should be noted that the widening element 12 configured for the necking, or subdivision, into groups, of at least one portion H of the shanks D of distinct electric conductors C (preferably the widening element 12 will be configured for necking or subdividing into groups constituted by at least two portions H, as illustrated by way of non-limiting example in the accompanying figures) that protrude from a respective ferromagnetic core A, comprises at least one septum 16 that is very thin.

Such septum 16 will profitably be configured for a translation along a direction parallel to the longitudinal axis of the shanks D of the conductors C: such translation in a direction parallel to the axis of the shanks will enable the septum 16 to enter the gap 17 delimited between two contiguous shanks D of distinct electric conductors C up to a predefined extent of their length.

The septum 16 will furthermore be usefully configured to also execute an additional translation, along a direction which is substantially transverse with respect to the longitudinal axis of the shanks D, for the deformation of part of such shanks D according to a predefined geometry (so as to obtain the alignment of the terminal fronts E of some shanks D of distinct conductors C according to the specifications of the circuit diagram for the inductive winding that it is intended to provide).

It should be noted that the apical part 18 of the septum 16 can advantageously be wedge-shaped (i.e. with a thickness that decreases up to its terminal edge): this particular shape structure will facilitate its entry into any gap 17 defined between two contiguous shanks D.

With particular reference to the characteristics of the conductors that it is possible to process using the apparatus 1 according to the invention, it should be noted that the terminal front E of the shank D of the concerned electric conductors C must be tapered.

The tapered surfaces L of the terminal front E of two contiguous shanks D of distinct conductors C will define respective inclined planes that converge toward the gap 17 delimited between contiguous shanks D.

In order to obtain the condition described, it is necessary that the inclined and tapered surfaces L are at least two in number and that, in the extreme case of the wedge-shaped terminal front E, they are arranged so as to constitute a ramp to guide the septum 16 toward the gap 17.

In greater detail, it should be noted that the terminal front E of the shanks D of the electric conductors C can have a shape structure chosen among wedge-shaped (in such case, the wedge will advantageously have its apical edge parallel to the surfaces that delimit the gap 17 between the contiguous shanks D of distinct conductors C), pyramidal, truncated pyramidal, conical, frustum-shaped, partially spherical, partially ellipsoidal, partially shaped like a parabolic, and the like.

The shape structure of the terminal front E must be tapered so as to facilitate the guiding of the septum 16 toward the gap 17: the tapering will allow small deformations of the portions H of the shanks D if the septum 16 is forced thereon, up to the point when the septum 16 is correctly directed toward the gap 17 into which it will be inserted.

The thin septum 16 comprises an edge (of the apical part 18) facing the front E of the shanks D. During the translation along the direction parallel to the longitudinal axis of the shanks D of the conductors C, such edge (of the apical part 18) will conveniently abut against parts (the inclined surfaces L) of the terminal front E of one of the two shanks D that delimit the gap 17 into which the septum 16 is to be inserted. This will determine a consequent guiding of the septum 16 toward the gap 17, effected by the surfaces L of those parts of the terminal front E that substantially constitute inclined planes.

In greater detail, it should be noted that an embodiment of proven functionality of the grouping device 10 can positively further comprise a twisting element 10a which comprises at least one first bushing 10b, 10c and at least one second bushing 10d, 10e. Such bushings 10b, 10c, 10d, 10e will preferably have a circular cross-section, be mutually concentric and mounted so that they can rotate about a third axis of symmetry 2c of such twisting element 10a (in practice the bushings 10b, 10c, 10d, 10e will have, with respect to the axis 2c, at least one degree of freedom of rotation about that axis 2c). Each one of the at least first and second bushings 10b, 10c, 10d, 10e will be provided with respective channels 10f, 10g, 10h, 10j which are configured to accommodate widened longitudinal portions H constituting terminal parts of the shanks D of each conductor C to be twisted, arranged parallel to the third axis of symmetry 2c.

It should be noted that, relative to the arrangement and to the rotary movement allowed to the at least one first and one second bushing 10b, 10c, 10d, 10e, the third axis of symmetry 2c coincides with the second axis of symmetry 2b.

The twisting element 10a of the apparatus 100 further comprises at least one movement element (not shown in the accompanying figures but which can be provided in a manner known to a person skilled in the art and/or belonging to the background art) for the at least one first and one second bushing 10b, 10c, 10d, 10e, which will be configured for the mutual rotation of the at least first bushing 10b, 10c and a second bushing 10d, 10e, thus obtaining the twisting of the longitudinal portions H. The rotation of the bushings 10b, 10c, 10d, 10e will be effected along a stroke from an initial position wherein the longitudinal portions H maintain the shape before being accommodated in said channels (10f, 10g, 10h, 10j), to a final position, wherein each portion H deformed by means of twisting the conductors C is circumferentially offset (along an arc of circumference) until a different configuration of alignment of the radially contiguous portions H is reached.

It should be noted that in the case in which the grouping device 10 comprises both a widening device and a twisting element 10a, the longitudinal portions H to be inserted in the bushings 10b, 10c, 10d, 10e of the twisting element 10a will already present a widened shape as a result of the operations performed in the widening element 12. In such case the rotation of the bushings 10b, 10c, 10d, 10e will be effected along a stroke from an initial position wherein the longitudinal widened portions H maintain the shape received from the widening element 12.

The apparatus 100 further comprises a device 13 for mutual coupling which is configured to couple longitudinal portions H belonging to a same winding.

The device 13 for mutual coupling preferably comprises, in turn, a welding unit configured to weld together at least two contiguous terminal fronts E, substantially positioned at the same axial height without requiring advance cutting operations to equalize the axial protrusion or overhang with respect to the ferromagnetic core.

It should further be noted that the device 13 (not shown in its entirety in the accompanying figures in that it is of substantially known type; purely for the purposes of non-limiting example such device 13 may correspond to the device described in WO2022136488) for the stable mutual coupling of portions H belonging to a same group of shanks D comprises a laser welding unit for welding together the fronts E (and also part of the adjoining portions H).

The laser welding unit comprises a control and management module for means configured to orientate and move the laser beam along the terminal fronts E of the shanks D of groups of electric conductors C according to a programmable rule of motion. By selecting a suitable rule of motion it is possible to obtain the melting of the terminal fronts E, initially localized exclusively in the center-most region of each front E, and, subsequently, spreading to all of the fronts E of the same group, welding them together.

The scope of the present invention further refers to a method for forming a lattice 3 of electric conductors C for windings of electric machines, wherein each conductor C is of the hairpin type, fork-shaped with two straight shanks D of different length joined by a bridge F. In such conductor C shaped like a forked hairpin, each shank D comprises a respective terminal front E.

The method comprises the following steps.

A step II of forming an annular lattice 3 within a tool 4 for temporarily accommodating the conductors C (such tool 4 having a first axis of symmetry 2a), by arranging the electric conductors C according to a predefined pattern within such tool 4. During such step II of forming a lattice 3, the conductors C are arranged within the tool 4 with the terminal fronts E of the shanks D lying on radial planes, with the longer shank further away from the first axis of symmetry 2a and with the bridges F of each conductor C arranged substantially at the same axial height and protruding above the tool 4.

There follows a step III of applying a push on the lattice 3 with respect to the tool 4 by means of a pusher 8, which can move in the direction of the first axis of symmetry 2a. The pusher 8 will be provided with an operative face 8a designed to abut against the terminal front E of the shanks D of the electric conductors C of the lattice 3.

During the pushing step III, the conductor elements C are not subjected to plastic deformations, because the sole objective of the push is to axially move the conductors C so they can be further manipulated by an extractor element 9 which, by embracing the lattice 3, can extract it completely from the tool 4, moving all of the conductors C to another station for inserting the lattice 3 into a ferromagnetic core A.

According to the invention, the operative face 8a of the pusher 8 will abut simultaneously against the terminal fronts E of the electric conductors C at different axial heights along the radial direction.

Such operative face 8a will be moved axially, while remaining in abutment against the terminal fronts E (i.e. abutting against the respective fronts E), until it partially lifts the shanks D of the electric conductors C that form the lattice from the forming tool 4 (i.e., by means of synchronized lifting, making all the conductors C that form the lattice 3 “emerge” or “rise” with respect to the top of the forming tool 4). In fact, since there are no other external forces in play (apart from weight, i.e. gravitational force) during the step pushing III, the single possible effect will be that the lattice 3 will rise, no substantial plastic deformation of the conductors C being expected that could alter their geometry with respect to the first forming step II of the lattice 3.

During such operation the shanks D remain straight, so as to allow a subsequent extraction of the lattice 3 from the forming tool 4.

It is important to note that the shape of the conductors C is kept substantially constant during the forming step II of the lattice 3 and the step pushing III of the lattice 3 (for its egress from the forming tool 4), no substantial plastic deformation being envisaged and/or determined.

It should be noted that the method according to the invention can profitably comprise a preliminary step I of preparing a plurality of electric conductors C, wherein the length of each shank D is greater the further away the position that it is to adopt in the lattice 3 with respect to a first axis of symmetry 2a.

This additional preliminary step I therefore also entails cutting each conductor C to the right length, optionally removing the layer of surface insulation from specific terminal portions of the shanks D of the conductor C, and optionally shaping it in order to give it a specific shape such as for example the shape known as “hairpin” (thus called because it is similar to the shape of a hairpin).

Each conductor C thus prepared will be suitable for providing a specific part of the corresponding inductive winding, without the need for any further cutting of any end portion thereof.

The method for forming windings will further comprise a step of extracting IIIa the lattice 3 from the forming tool 4 in order to subsequently insert such lattice 3 in the ferromagnetic core A (as already explained for step III, no substantial plastic deformations of the conductors C will occur in step IIIa either).

It should be noted that, after the extraction step IIIa, the method for forming windings can profitably comprise the following steps:
A transferring step IV of the lattice 3 into the ferromagnetic core A, arranging each shank D of each conductor C inside a respective slot B of such core A.
A grouping step V of such shanks D in groups: each one of such groups will comprise at least shanks D of the conductors C that are arranged in the core A at a same radial distance from the second axis of symmetry 2b, affecting a respective longitudinal portion H which is contiguous with the terminal front E, for each shank D of the group.
A coupling step VI of the terminal fronts E of the already-grouped (i.e. deformed by performing a widening in a radial direction widening and/or determining an at least partial twisting of at least one part thereof) portions H belonging to a same winding.

It should be noted that, after the step of grouping V, the terminal fronts E of each one of the conductors C belonging to different groups have, in the final position, substantially the same axial height with respect to the direction of said second axis of symmetry 2b, thus being unnecessary to have a further step of cutting the longitudinal portions H in order to equalize the axial protrusion of the terminal fronts E of the conductors C inserted in said core A before the step VI of coupling.

It should be noted that the grouping step V can usefully comprise a necking step Va, consisting in the symmetrical deformation of groups of such longitudinal portions H in a radial direction with respect to the second axis of symmetry 2b, by means of a widening element 12 that comprises at least one septum 16. Such widening element 12 is firstly moved in a direction parallel to the second axis of symmetry 2b so that the respective septum 16 is axially inserted into a gap 17 delimited between two radially adjacent longitudinal portions H up to a predefined axial height with respect to the second axis of symmetry 2b. Subsequently, the element 12 will be moved in a radial direction with respect to the second axis of symmetry 2b, for the deformation in the radial direction of the shanks D of the portions H according to a predefined geometry.

It should further be noted that the grouping step V can usefully comprise a twisting step Vb wherein the longitudinal portions H of each one of the at least two groups of shanks D arranged at a same radial distance are firstly inserted in at least one respective rotating annular bushing 10b, 10c, 10d, 10e of a twisting element 10a. In such step Vb, each one of the bushings 10b, 10c, 10d, 10e must be symmetrical with respect to a third axis of symmetry 2c, which coincides with the second axis of symmetry 2b during the twisting step Vb. Subsequently, the at least two bushings 10b, 10c, 10d, 10e will be reciprocally rotated from an initial position to a final position so as to deform the longitudinal portions H of each one of the at least two groups of shanks D: such deformation will be obtained by circumferentially (i.e. along a substantially circular trajectory) offsetting the terminal fronts E of the shanks D until they reach, in the final position, a different configuration of alignment of the radially contiguous portions H.

The coupling step VI will advantageously be performed by means of a laser welding operation wherein at least one laser source will generate at least one respective beam, said at least one beam will profitably be movable along the terminal fronts E of electric conductors C of the same winding to be welded according to a predetermined pattern.

Such welding can profitably be performed by means of a laser, the beam of which can move along the terminal fronts E of the shanks D of groups of electric conductors C to be welded according to a programmable rule of motion. This will bring such terminal fronts E to liquefaction by virtue of the many passes of the laser beam thereon along preset trajectories and at preset intervals.

It is convenient to note that the method implemented with the station 1 according to the invention does not comprise any operation to cut parts of the electric conductors C after the first step of preparing a plurality of electric conductors C of predefined lengths.

Advantageously the present invention solves the above-mentioned problems, by providing a station 1 integrated in an apparatus 100 and a method for forming inductive windings of electric machines that can easily operate on lattices 3 of conductors C wherein the shanks D do not need to be cut before they are coupled together in groups of at least two shanks D.

The apparatus 100, the station 1 comprised in it, and the method according to the invention in fact can use conductors C of the proper length necessary for providing the winding, thus eliminating the cutting station required in most conventional plants (which determines a considerable increase in cost for the plant, requires periodic maintenance, consumes energy and generates great amounts of discarded portions of conductors C).

Conveniently, the apparatus 100 and the method according to the invention do not therefore comprise the cutting station for the shanks D of the conductors C.

Advantageously the apparatus 100, the station 1 and the method according to the invention do not entail the use of high-precision machines for executing the operations to insert the shanks D into respective seats 5 of the forming tool 4, during the formation of the lattice 3, and into the slots B of the ferromagnetic core A, during the introduction of the lattice 3 into the ferromagnetic core A.

Such high-precision machines are not necessary because the pointed shape of the terminal fronts E of the shanks D of the conductors C facilitates their entry into the seats 5 and into the slots B.

Usefully the apparatus 100, the station 1 and the method according to the invention do not entail the adoption of auxiliary components to ensure the precise alignment of each terminal front E with the respective seats 5 of the forming tool 4, during the formation of the lattice 3, and with the slots B of the ferromagnetic core A, during the introduction of the lattice 3 into the ferromagnetic core A.

Such auxiliary components are not necessary because the pointed shape of the terminal fronts E of the shanks D of the conductors C facilitates their entry into the seats 5 and into the slots B.

Profitably the apparatus 100, the station 1 and the method according to the invention make it possible to apply the teachings of WO2022136488 in the final step of coupling separate shanks D of conductors C by means of a welding process.

Positively the apparatus 100, the station 1 and the method according to the invention are easily and practically implemented and are of low cost: such characteristics make the apparatus 100, the station 1 and the method according to the invention innovations that are certain to be used.

The invention, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in Italian Patent Application No. 102022000024435, from which this application claims priority, are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-17. (canceled)

18. A station for forming a lattice of inductive windings of electric conductors of the hairpin type, wherein each conductor is fork-shaped with two straight shanks of different length joined by a bridge, said station comprising:
a forming tool configured to temporarily accommodate a plurality of said conductors about a first axis of symmetry, so as to form said lattice with the bridges of each conductor arranged substantially at a same axial height; and
a pushing element configured to be moved along said first axis of symmetry so as to push said lattice with respect to the forming tool, said pushing element comprising a pusher provided with an operative face designed to abut against terminal fronts of the straight shanks of said electric conductors which form said lattice;
wherein said operative face of said pusher has a radially-inclined annular configuration with a protrusion that decreases as it progresses further away from the first axis of symmetry, so as to abut against said electric conductors at different axial heights along a radial direction, said operative face being configured to move axially while remaining in abutment against said terminal fronts, until it partially lifts the shanks of the electric conductors that form the lattice from the forming tool, so as to enable a subsequent extraction of said lattice from said forming tool by means of an extractor element.

19. The station according to claim 18, wherein said operative face of said pusher has a configuration of a type chosen at least among frustum-shaped, hemispherical, spheroidal, parabolic-shaped, hyperboloid-shaped or polyhedral.

20. The station according to claim 18, wherein said forming tool comprises a main body which is symmetrical with respect to the first axis of symmetry and is provided with a plurality of seats, each one of said seats being configured to accommodate at least one shank of the electrical conductor in a direction parallel to the first axis of symmetry.

21. The station according to claim 20, wherein said seats are arranged circumferentially, separated from each other by a respective radial septum.

22. The station according to claim 18, wherein said forming tool comprises a first surface and an opposing second surface from which the bridges of the conductors forming said lattice protrude, said pusher being configured to be movable parallel to the first axis of symmetry from a first configuration, wherein the pusher is arranged spaced apart from said second surface, to a second configuration, wherein said operative face of said pusher is closer to the second surface with respect to the first configuration, and the shanks of the electric conductors protrude partially from said second surface.

23. An apparatus for forming inductive windings arranged within through slots of a ferromagnetic core of an electric machine, comprising at least:
a station for forming lattices of inductive windings according to claim 18;
an extractor element configured to extract the lattice of electric conductors from the forming tool and subsequently insert the lattice into a ferromagnetic core which is symmetrical with respect to a second axis of symmetry, so that each shank of the conductors is accommodated in a respective slot of said core; and
a grouping device configured for a subdivision of said shanks into groups, each one of the groups comprising at least shanks of the conductors that are arranged in the core at a substantially same radial distance from said second axis of symmetry, said grouping device being dimensioned to affect, for each shank of said group, a longitudinal portion which is contiguous with the terminal front.

24. The apparatus according to claim 23, wherein said grouping device comprises a widening element configured and dimensioned, firstly, to effect a translation parallel to the second axis of symmetry, so as to be inserted into a gap present between two radially adjacent shanks of distinct electric conductors, affecting said longitudinal portion of the shanks up to a predefined axial height and, secondly, for an additional translation along a radial direction with respect to the second axis of symmetry, for the at least partial deformation of portions of said shanks in a direction away from the second axis of symmetry.

25. The apparatus according to claim 24, wherein said widening element comprises at least one septum configured and dimensioned to be inserted axially into said gap, wherein said at least one septum comprises an edge configured and dimensioned, firstly, to face the terminal front of said shanks during the translation along said direction parallel to the second axis of symmetry, and, secondly, to abut against parts of said terminal front of one of the two shanks that delimit the gap.

26. The apparatus according to claim 23, wherein said grouping device further comprises a twisting element comprising:
at least one first bushing and at least one second bushing, circular in cross-section, mutually concentric and mounted so that they can rotate about a third axis of symmetry of said twisting element, each one of said at least one first and second bushing being provided with respective channels which are configured to accommodate longitudinal portions constituting terminal parts of the shanks of said conductor to be twisted, and arranged parallel to said third axis of symmetry, wherein said third axis of symmetry coincides with said second axis of symmetry, and
an element for moving the at least first and second bushing, being configured for the mutual rotation of said at least first bushing and second bushing, thus obtaining the twisting of said widened longitudinal portions, said rotation of the bushings) being effected from an initial position, wherein the longitudinal portions maintain the shape before being accommodated in said channels, to a final position, wherein each portion deformed by means of twisting the conductors is circumferentially offset until a different configuration of alignment of the radially contiguous portions is reached.

27. The apparatus according to claim 23, further comprising a device for mutual coupling configured to couple longitudinal portions belonging to a same winding, said device for mutual coupling comprising a welding unit configured to weld together at least two contiguous terminal fronts, substantially positioned at a same axial height without requiring cutting operations to equalize an axial protrusion with respect to the ferromagnetic core.

28. A method for forming a lattice of electric conductors for windings of electric machines, wherein each conductor is of a hairpin type shaped like a fork with two straight shanks of different length joined by a bridge wherein each shank comprises a respective terminal front, said method comprising the steps of:
I. forming an annular lattice within a tool for temporarily accommodating said conductors which has a first axis of symmetry, by arranging said electric conductors according to a predefined pattern within said tool, wherein said conductors are arranged accommodated within the tool with terminal fronts of the shanks lying on radial planes, with a longer shank further away from said first axis of symmetry, and with bridges of each conductor arranged substantially at a same axial height and protruding from said tool;
II. applying a push on said lattice with respect to said tool, by means of a pusher which can move in a direction of the first axis of symmetry, said pusher being provided with an operative face designed to abut against the terminal front of the shanks of said electric conductors of the lattice;
wherein said operative face simultaneously abuts against the terminal fronts of said electric conductors at different axial heights along a radial direction, said operative face being moved axially while remaining in abutment against said terminal fronts, until the operative face partially lifts the shanks of the electric conductors that form the lattice from the forming tool, wherein said shanks remain straight, so as to enable a subsequent extraction of said lattice from said forming tool.

29. The method according to claim 28, further comprising a preliminary step of preparing a plurality of electric conductors, wherein the length of each shank is greater the further away is a position that is to be adopted in the lattice with respect to a first axis of symmetry.

30. A method for forming inductive windings of electric machines of the type arranged within through slots of a ferromagnetic core that is symmetrical with respect to a second axis of symmetry, comprising:
a step of forming a lattice of electric conductors according to claim 28,
a step of extracting said lattice from said forming tool in order to subsequently insert said lattice in the ferromagnetic core.

31. The method for forming inductive windings of electric machines according to claim 30, wherein after the step of extraction it comprises the steps of:
III. transferring said lattice into said ferromagnetic core, arranging each shank of each conductor inside a respective through slot of said core;
IV. grouping said shanks in groups, each one of said groups comprising at least shanks of the conductors that are arranged in the core at a same radial distance from said second axis of symmetry, affecting, for each shank of said group, a respective longitudinal portion which is contiguous with the terminal front;
V. coupling together the terminal fronts of the already-grouped portions belonging to a same winding;
wherein after the step of grouping the terminal fronts of each one of the conductors belonging to different groups have, in a final position, substantially a same axial height with respect to the direction of said second axis of symmetry, thus being unnecessary to have a further step of cutting the longitudinal portions in order to equalize the axial protrusion of the terminal fronts of the conductors inserted in said core before the step of coupling.

32. The method according to claim 31, wherein said step of grouping comprises a necking step which consists in the symmetrical deformation of groups of said longitudinal portions in a radial direction with respect to said second axis of symmetry by means of a widening element comprising at least one septum, wherein said widening element, firstly, is moved in a direction parallel to said second axis of symmetry so that the septum of said widening element is inserted axially into a gap delimited by two radially-adjacent longitudinal portions up to a predefined axial height with respect to said second axis of symmetry and, subsequently, is moved in a radial direction with respect to the second axis of symmetry, for the deformation in a radial direction of the shanks of said portions according to a predefined geometry.

33. The method according to claim 31, wherein said step of grouping comprises a step of twisting wherein the longitudinal portions of each one of the at least two groups of shanks arranged at a same radial distance are firstly inserted in at least one respective rotating annular bushing of a twisting element, each one of said bushings, being symmetrical with respect to a third axis of symmetry coinciding with said second axis of symmetry during the step of twisting and, subsequently, said at least two bushings are reciprocally rotated from an initial position to a final position so as to deform the longitudinal portions of each one of the at least two groups of shanks, thus circumferentially offsetting the terminal fronts of said shanks until they reach, in the final position, a different configuration of alignment of the radially contiguous portions.

34. The method according to claim 31, wherein said step of coupling together is performed by means of a laser welding operation wherein at least one laser source generates at least one respective beam, said at least one beam being movable along the terminal fronts of electric conductors of the same winding to be welded according to a predetermined pattern.
